(19) United States
(12) Patent Application Publication
(10) Pub. No.: US 2019/0339178 A1
(43) Pub. Date: Nov. 7, 2019

(54) TIRE LOAD APPLICATION DEVICE AND TIRE INSPECTION DEVICE

(71) Applicant: TOYO TIRE CORPORATION, Itami-shi (JP)

(72) Inventor: Koji Arakawa, Itami-shi, Hyogo (JP)

(73) Assignee: TOYO TIRE CORPORATION, Itami-shi (JP)

(21) Appl. No.: 16/390,480

(22) Filed: Apr. 22, 2019

(30) Foreign Application Priority Data
May 7, 2018 (JP) 2018-089098

(51) Int. Cl. G01N 3/06; B29D 30/00; G01N 3/08

(52) U.S. Cl. CPC G01N 3/068; B29D 30/0061; G01N 2203/0647; B29D 2030/0066; G01N 3/08

(57) ABSTRACT

A tire load application device includes a support base having a support surface against which part of a tread surface of a tire abuts, a support member configured to support an inner circumferential side of the tire and protrude toward both end sides in a tire axial center direction, and a longitudinal load application mechanism configured to apply a load to both end portions of the support member and press the tire toward the support surface.

### CROSS-REFERENCE TO RELATED APPLICATIONS

This application claims priority of Japanese Patent Application No.: 2018-089098 filed on May 7, 2018, the content of which is incorporated herein by reference.

### BACKGROUND OF THE INVENTION

### Technical Field

The present invention relates to a tire load application device and a tire inspection device.

### Related Art

In tire design, it is important to accurately evaluate a deformation state and strain distribution (tension distribution) of cord members, such as a ply and a belt which are frameworks.

In the finite element method (FEM) used for general tire design, distortion of a cord member occurring in an initial state of a product tire cannot be taken into consideration. In order to improve the accuracy of the FEM, a tire model that takes into consideration the distortion of a code member occurring in an initial state is necessary.

Therefore, for example, there has been proposed a tire internal structure observation device that allows observation of an internal structure of a tread portion of a tire by emitting a radiation source X-ray to a tire pressed against a belt member by a loading mechanism and performing detection with a radiation detector (for example, see JP 2006-308316 A).

However, the device described in JP 2006-308316 A is configured to support a tire in a cantilever manner, and there is a problem that a support structure is large in scale so that a predetermined strength is obtained.

### SUMMARY

An object of the present invention is to provide a tire load application device capable of applying an appropriate load to a tire in spite of its simple and inexpensive structure and a tire inspection device capable of accurately grasping an internal structure of a tire by using the tire load application device.

As means to achieve the above object, the present invention provides a tire load application device, including a support base having a support surface against which part of a tread surface of a tire abuts, a support member configured to support an inner circumferential side of the tire and protrude toward both end sides in a tire axial center direction, and a longitudinal load application mechanism configured to apply a load to both end portions of the support member and press the tire toward the support surface.

With this configuration, a load is applied to both end portions of the support member. Accordingly, excessive equipment is unnecessary unlike a case where a cantilever beam is employed.

The longitudinal load application mechanism is preferably configured with a pair of longitudinal load application members that allow a tensile force to act on both end portions of the supporting member toward the supporting surface.

The longitudinal load application member is further preferably a shaft member whose length can be adjusted.

A bearing portion rotatably supporting both end portions of the support member is included, and the longitudinal load application mechanism may be configured with a pair of pressing members that press the tire toward the support surface via the bearing portion.

A lateral load application member that applies a load toward an axial center direction to the support member is preferably further included.

With this configuration, a load acting on a tire at the time of cornering can be virtually applied.

As means for achieving the above object, the present invention provides a tire inspection device including a tire load application device having any of the above configurations, X-ray irradiating means for irradiating the tire with an X-ray from a tire axial center direction, and X-ray detecting means for detecting an X-ray emitted from the X-ray irradiating means and passing through the tire. The support surface is rotatable about a rotation axis parallel to a tire axial center.

With this configuration, when the support surface is inclined with respect to a horizontal surface and the tire is irradiated with an X-ray, a thickness of a belt cord metal portion through which the X-ray passes can be reduced. As a result, attenuation of an X-ray can be suppressed and a clear image can be acquired.

The tire load application device according to the present invention, despite its simple and inexpensive configuration, can apply an appropriate load to a tire.

Further, the tire inspection device according to the present invention can grasp an internal structure of a tire accurately.

### BRIEF DESCRIPTION OF THE DRAWINGS

The foregoing and the other features of the present invention will become apparent from the following description and drawings of an illustrative embodiment of the invention in which:

FIG. 1 is a front view of a tire load application device according to the present embodiment;

FIG. 2 is a plan view of a support base shown in FIG. 1;

FIG. 3 is a side view of a load application member shown in FIG. 1;

FIG. 4 is a front view showing a state in which the tire load application device shown in FIG. 1 is inclined; and

FIG. 5 is a front view of the tire load application device according to another embodiment.

### DETAILED DESCRIPTION OF EMBODIMENTS

Hereinafter, embodiments according to the present invention will be described with reference to the accompanying drawings. It should be noted that description below is merely exemplary in nature and is not intended to limit the invention, its application, or its use. Further, the drawings are schematic, and ratios of dimensions do not necessarily agree with actual ones.

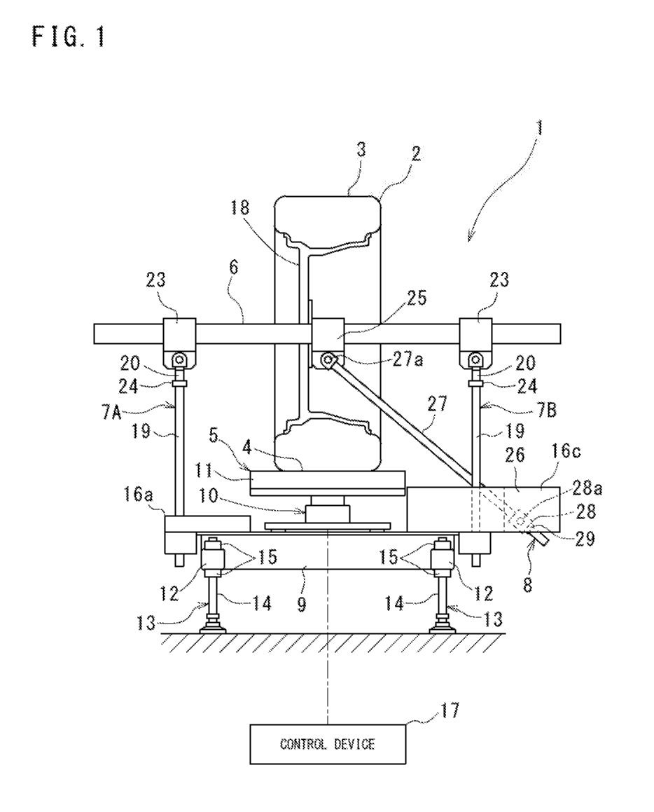

FIG. 1 shows a tire load application device 1 according to the present embodiment. The tire load application device 1 includes a support base 5 having a support surface 4 on which part of a tread portion 3 of a tire 2 abuts, a support member 6 supporting an inner circumferential side of the tire 2, a longitudinal load application mechanism including a pair of longitudinal load application members 7A and 7B for pressing the tire 2 against the support surface 4 with the support member 6 interposed between them, and a lateral load application member 8 pulling the tire 2 in a horizontal direction with the support member 6 interposed between them.

The support base 5 includes a base 9, a load cell 10, and a support plate 11.

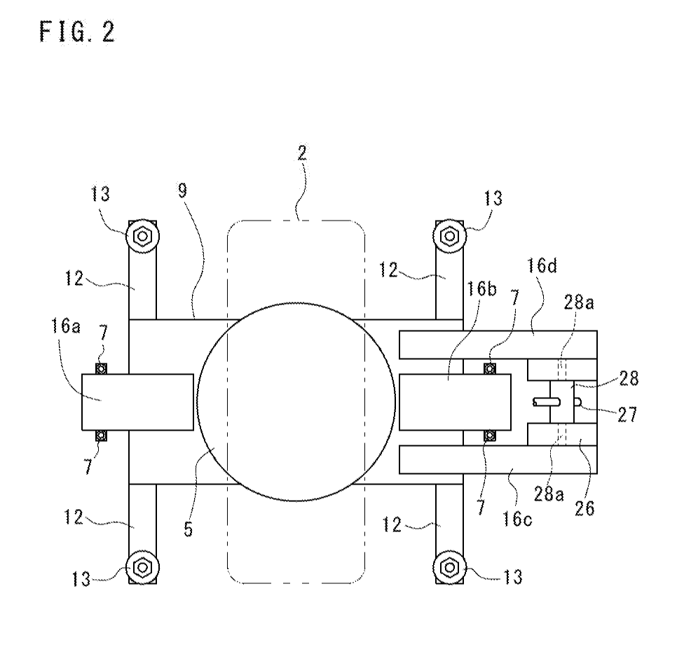

The base 9 is formed of a plate-like body having a rectangular shape in plan view. Extending portions 12 extend from four corners of the base 9 in the horizontal direction (vertical direction in FIG. 2) on both sides. A height adjusting member 13 is attached to a tip portion of each of the extending portions 12. In the present embodiment, the height adjusting member 13 is configured with a rod 14 vertically penetrating the tip portion of each of the extending portions 12, and a pair of upper and lower nuts 15 threadedly engaged with a male screw formed on an outer circumferential surface of the rod 14. By changing a screwing position of the nuts 15 sandwiching the extending portion 12, a projecting dimension of the rod 14 toward a lower side from the extending portion 12 can be adjusted. Here, the height adjusting member 13 is used for adjusting an inclination angle of the support plate 11. That is, by changing positions of the nuts 15 on the rods 14 in two locations positioned in one or both sides in a tire width direction, an inclination angle of the support plate 11 can be adjusted. A lower end portion of the rod 14 is expanded in a circular shape so that a state of placement on the ground is stabilized.

Fixed blocks 16a and 16b are fixed to both end sides on an upper surface of the base 9. A lower end portion of the longitudinal load application member 7A described later is fixed to the fixed block 16a on one side and a lower end portion of the longitudinal load application member 7B is fixed to the fixed block 16b on the other side. Further, on one end side on an upper surface of the base 9, auxiliary blocks 16c and 16d are fixed to both sides of the fixed block 16b. Lower end portions of connecting rods 19 of the lateral load application member 8 are connected to the auxiliary blocks 16c and 16d.

A load cell 10 is fixed between the base 9 and the support plate 11. The load cell 10 expands an amount of deformation caused by a load acting on the support plate 11, converts it into an electric signal with a strain gauge (not shown), and outputs it to a control device 17. The control device 17 calculates the load acting on the support plate 11 based on the input electric signal from the strain gauge.

The support plate 11 is made from a material excellent in permeability, such as wood, acrylic, or the like, that is, a material in which a transmitted X-ray is hardly attenuated. The upper surface of the support plate 11 serves as the support surface 4 against which a portion of the tread portion 3 of the tire 2 abuts. An inclination angle of the support plate 11 with respect to a horizontal plane can be adjusted by the height adjusting member 13 provided on the base 9. Here, a tread surface of the tire 2 to be placed is inclined with respect to the horizontal plane in the tire width direction.

The support member 6 is a cylindrical body made from a metal material, such as stainless steel. Both end portions of the support member 6 are connected to and supported by the fixed blocks 16a and 16b of the support base 5 by the longitudinal load application members 7A and 7B which will be described later. The tire 2 is attached to the support member 6. The tire 2 is fixed to a wheel 18 with a first attachment portion 25 described later interposed between them in a state in which the support member 6 is inserted through a center hole of the attached wheel 18. As a result, a load can be applied to the tire 2 toward the support surface 4 of the support plate 11 via the support member 6 by the longitudinal load application members 7A and 7B.

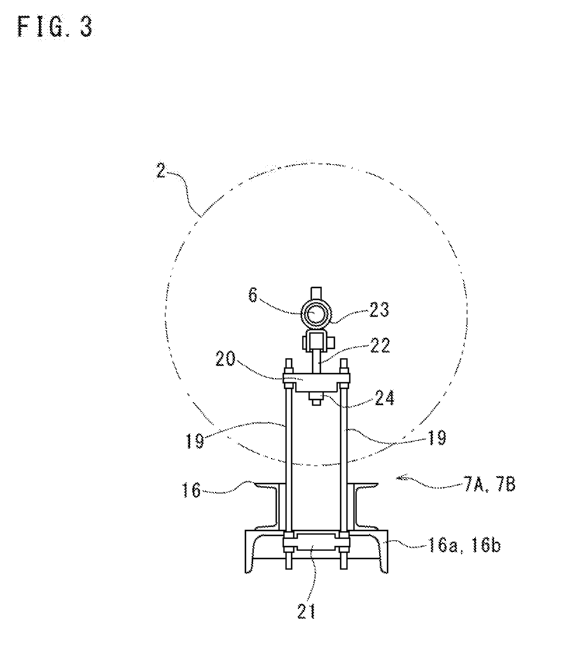

The longitudinal load application members 7A and 7B constituting the longitudinal load applying mechanism connect both end sides of the support member 6 and the support base 5 in such a manner that a length between them is adjustable. The longitudinal load application members 7A and 7B are disposed in both end portions in a longitudinal direction of the support plate 11. With reference also to FIG. 3, each of the longitudinal load application members 7A and 7B includes a pair of the connecting rods 19 arranged at predetermined intervals, a first connecting portion 20 connecting the connecting rods 19 in an upper end portion, and a second connecting portion 21 connecting them in a lower end portion. The first connecting portion 20 is connected to a support ring 23 attached to the support member 6 with a longitudinal shaft portion 22 which is a shaft member of the present invention. A male screw is formed on the outer circumferential surface of the longitudinal shaft portion 22, and is threadedly engaged with a nut 24 in a lower side after passing through the first connecting portion 20. By changing the screwing position of the nut 24 at the longitudinal shaft portion 22, a tensile force acting on the support member 6 can be adjusted.

The lateral load application member 8 includes an inclined shaft portion 27 connected between a first attachment portion 25 fixed to the outer periphery of the support member 6 and a second attachment portion 26 fixed to the auxiliary blocks 16c and 16d. As shown in FIG. 1, one end portion of the inclined shaft portion 27 is connected to the first attachment portion 25 so as to be rotatable around a support shaft 27a. The second attachment portion 26 is provided with a bearing portion 28 which is rotatable around a support shaft 28a. A male screw is formed on an outer circumferential surface of the other end portion of the inclined shaft portion 27. The inclined shaft portion 27 is caused to pass through the bearing portion 28 in a state where the other end portion is slidable in an axial center direction. A nut 29 is threadedly engaged with the inclined shaft portion 27 in a projecting portion from the bearing portion 28. By changing the screwing position of the nut 29 in the inclined shaft portion 27, a tensile force acting on the support member 6 can be adjusted. That is, it is possible to set a load in a lateral (horizontal) direction acting on the tire 2 via the support member 6.

The tire load application device 1 is used as described below.

The tire 2 is attached from one end side of the support member 6 in a state where the longitudinal load application member 7A is removed from the support member 6. That is, the support member 6 is inserted into a center hole of the wheel 18 attached to the tire 2, so that the wheel 18 attached to the tire 2 is attached to the first attachment portion fixed to the support member 6. Further, the longitudinal load application member 7A is attached to the support member 6. At this time, an internal pressure of the tire 2 is set as a normal internal pressure. Here, the normal internal pressure means an internal pressure defined by standards on which a tire relies on, that is, a “maximum air pressure” in the JATMA standard, a “maximum value” stated in “TIRE LOAD LIMITS AT VARIOUS COLD INFLATION PRESSURES” in the TRA standard, and “INFLATION PRESSURE” in the ETRTO standard. Note that the internal pressure of the tire 2 is not limited to the normal internal pressure, and may be appropriately changed according to a purpose.

Next, the screwing positions of the nuts 24 of the longitudinal load application members 7A and 7B are changed, and a tensile force is applied to the tire 2 via the support member 6 to press the tire 2 against the support surface 4 of the support plate 11. The pressing force is measured by a detection signal from the load cell 10. When a measured value reaches a desired value, tightening of the nut 24 is stopped. Here, the pressing is performed until the measured value reaches a normal load. Further, the normal load means a load defined by standards on which the tire 2 relies on, that is, “maximum loading capability” in the JATMA standard, a “maximum value” stated in “TIRE LOAD LIMITS AT VARIOUS COLD INFLATION PRESSURES” in the TRA standard, and “LOAD CAPACITY” in the ETRTO standard. Note that although the tightening stopping timing of the nut 24 is set to be a time when the measured value reaches the normal load, the present invention is not limited to the normal load, and may be appropriately changed in accordance with a purpose.

Further, when a lateral load is applied to the tire 2, a tensile force is applied by operating the lateral load application member 8. In this case, among tensile forces acting on the tire 2 via the support member 6 by the longitudinal shaft portion 22 and the inclined shaft portion 27, a total value of components in a vertical direction toward the support surface 4 is a load that presses the tire 2 against the support surface 4, and a total value of components in the horizontal direction orthogonal to the support surface 4 is a lateral load acting on the tire 2.

According to the tire load application device 1, an advantageous effect described below can be obtained.

(1) A force for pressing the tire 2 against the support surface 4 of the support plate 11 can be adjusted merely by changing the screwing position of the nut 24 threadedly engaged with the longitudinal shaft portion 22 of longitudinal load application members 7 and the screwing position of the nut 29 threadedly engaged with the inclined shaft portion 27 of the lateral load application member 8.

(2) Since a tensile force is applied toward the support plate 11 on both end sides of the support member 6 and by the two connecting rods 19, a tensile strength required for each of the connecting rods 19 can be restricted. That is, a wire diameter of each of the connecting rods 19 can be reduced.

(3) Adjustment of the tensile force acting on the support member 6 can be performed simply by changing the screwing position of the nut 24 with respect to the longitudinal shaft portion 22 and the screwing position of the nut 29 with respect to the inclined shaft portion 27, and a simple and inexpensive configuration can be employed.

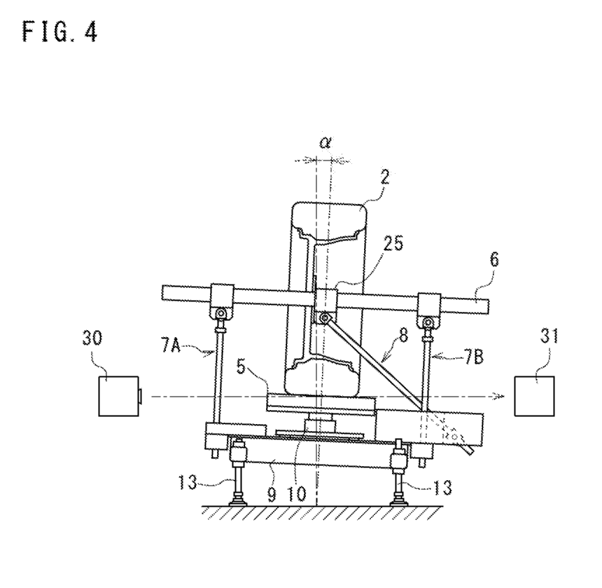

The tire load application device 1 having the above configuration can be used for a tire inspection device. As an inspection device for a tire, for example, as shown in FIG. 4, an X-ray CT device that can inspect an internal structure by irradiating the tire 2 with X-rays can be mentioned.

The X-ray CT device includes an X-ray irradiation section 30 which is an example of X-ray irradiating means of the present invention for irradiating the tire 2 attached to the tire load application device 1 with an X-ray, and an X-ray detection section 31 which is an example of X-ray detecting means of the present invention for detecting an X-ray that has passed through the tire 2.

The X-ray irradiation section 30 is disposed on a side of one of the longitudinal load application members 7 so that the tire 2 can be irradiated with X-rays from a tire axial center direction. Further, the X-ray detection section 31 is disposed on a side of the other one of the longitudinal load application members 7 on a side opposite to the X-ray irradiation section 30 with the tire load application device 1 interposed between them. The longitudinal load application member 7 is mainly configured with the connecting rod 19 having a narrow wire diameter, and hardly attenuates an X-ray emitted from the X-ray irradiation section 30. Therefore, an internal structure of the tire 2, for example, the wire of the belt can be appropriately detected.

Here, the support plate 11 is disposed so that the support surface 4 is horizontal, but it may also be inclined. For example, as shown in FIG. 4, by setting positions of the nuts 15 to a lower side on the rods 14 in two locations positioned on one side in the tire width direction by using the height adjusting member 13, the support surface 4 can be inclined obliquely downward on the right in the diagram. In FIG. 4, the tire 2 is inclined at an angle α with respect to the vertical direction. The longitudinal load application member 7 for pulling the tire 2 via the load cell 10 and the support member 6 is provided on the support plate 11. For this reason, the tire 2 is also inclined while being maintained a state of being orthogonal to the inclined support plate 11.

By irradiating the tire 2 inclined in this way with X-rays from the side, an image of the internal structure of part of the tread portion 3 in the tire width direction can be obtained. Therefore, there is no such a thing that an image becomes unclear due to a long distance of an attenuating portion, such as a wire, through which an X-ray passes, as in a case where the entire tread portion 3 is irradiated with X-rays from the side. In this case, members around X-ray irradiation regions, such as the load cell 10, are preferably also made from a material having excellent permeability, imaging can be performed even if the load cell 10 is positioned in a region through which an X-ray passes along with inclination of the tire 2.

It should be noted that the present invention is not limited to the configuration described in the above embodiment, and various modifications are possible.

In the above embodiment, the tire 2 is pulled by the longitudinal shaft portion 22 to the support base 5 via the support member 6. However, the tire 2 may be pulled by a member, such as a wire, which is relatively easy to deform in a direction other than the pulling direction.

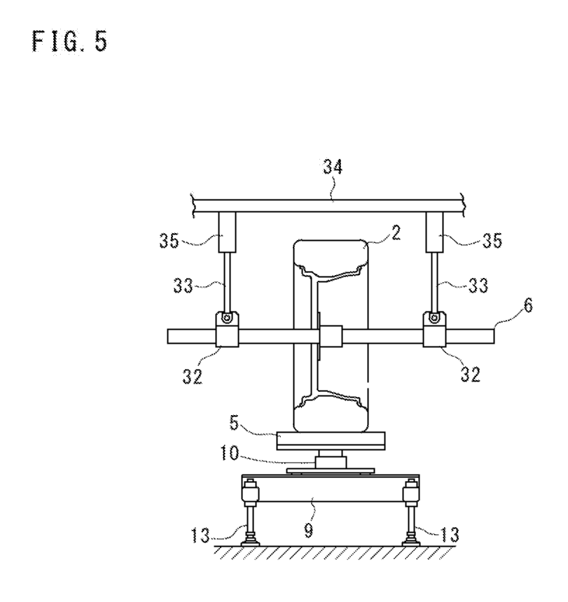

In the above embodiment, as the longitudinal load applying mechanism, the tire 2 is pulled by a pair of the longitudinal load application members 7 via the support member 6 to the support base 5. However, the mechanism may be configured to press the tire 2. Specifically, as shown in FIG. 5, a thrust bearing 32 is attached to the support member 6, and the thrust bearing 32 is pressed down by a pushing bar 33 which is a pressing member of the present invention, so that a vertically downward force acts on the support member 6. For pressing down the pushing bar 33, for example, an actuator 35 or the like fixed to a frame 34 provided on any of the X-ray CT device may be used.

Since the support member 6 is pressed against the support surface 4 from the opposite side as described above, even the longitudinal load application member 7 as in the above embodiment does not exist around the tread portion 3 of the tire 2 pressed against the support surface 4. Therefore, a radiated X-ray is not attenuated in portions other than a tire portion, and imaging of the tread portion 3 can be performed more clearly.

In the above embodiment, the tire 2 is configured to be pressed against the support base 5 disposed on a lower side. However, the pressing direction is not limited to the vertically downward direction, and may be freely set, such as a horizontal direction, an obliquely downward direction, and the like.

What is claimed is:

1. A tire load application device, comprising:
a support base having a support surface against which part of a tread surface of a tire abuts;
a support member configured to support an inner circumferential side of the tire and protrude toward both end sides in a tire axial center direction; and
a longitudinal load application mechanism configured to apply a load to both end portions of the support member and press the tire toward the support surface.

2. The tire load application device according to claim 1, wherein the longitudinal load application mechanism is configured with a pair of longitudinal load application members that allow a tensile force to act on both end portions of the supporting member toward the supporting surface.

3. The tire load application device according to claim 2, wherein the longitudinal load application member is configured with a shaft member whose length is adjustable.

4. The tire load application device according to claim 1, further comprising a bearing portion rotatably supporting both end portions of the support member, wherein
the load application mechanism is configured with a pair of pressing members that press the tire toward the support surface via the bearing portion.

5. The tire load application device according to claim 1, further comprising a lateral load application member that applies a load toward an axial center direction to the support member.

6. The tire load application device according to claim 2, further comprising a lateral load application member that applies a load toward an axial center direction to the support member.

7. The tire load application device according to claim 3, further comprising a lateral load application member that applies a load toward an axial center direction to the support member.

8. The tire load application device according to claim 4, further comprising a lateral load application member that applies a load toward an axial center direction to the support member.

9. A tire inspection device, comprising:
the tire load application device according to claim 1;
X-ray irradiating means for irradiating the tire with an X-ray from a tire axial center direction; and
X-ray detecting means for detecting an X-ray emitted from the X-ray irradiating means and passing through the tire, wherein
the support surface is rotatable about a rotation axis parallel to a tire axial center.

10. A tire inspection device, comprising:
the tire load application device according to claim 2;
X-ray irradiating means for irradiating the tire with an X-ray from a tire axial center direction; and
X-ray detecting means for detecting an X-ray emitted from the X-ray irradiating means and passing through the tire, wherein
the support surface is rotatable about a rotation axis parallel to a tire axial center.

11. A tire inspection device, comprising:
the tire load application device according to claim 3;
X-ray irradiating means for irradiating the tire with an X-ray from a tire axial center direction; and
X-ray detecting means for detecting an X-ray emitted from the X-ray irradiating means and passing through the tire, wherein
the support surface is rotatable about a rotation axis parallel to a tire axial center.

12. A tire inspection device, comprising:
the tire load application device according to claim 4;
X-ray irradiating means for irradiating the tire with an X-ray from a tire axial center direction; and
X-ray detecting means for detecting an X-ray emitted from the X-ray irradiating means and passing through the tire, wherein
the support surface is rotatable about a rotation axis parallel to a tire axial center.

13. A tire inspection device, comprising:
the tire load application device according to claim 5;
X-ray irradiating means for irradiating the tire with an X-ray from a tire axial center direction; and
X-ray detecting means for detecting an X-ray emitted from the X-ray irradiating means and passing through the tire, wherein
the support surface is rotatable about a rotation axis parallel to a tire axial center.
